(19) United States
(12) Patent Application Publication
(10) Pub. No.: US 2024/0337845 A1
(43) Pub. Date: Oct. 10, 2024

(54) OPTICAL WAVEGUIDE LENS AND NEAR-EYE DISPLAY DEVICE

(71) Applicant: AAC OPTICS (CHANGZHOU) CO., LTD., Changzhou City (CN)

(72) Inventor: Biming Zhang, Changzhou (CN)

(21) Appl. No.: 18/544,367

(22) Filed: Dec. 18, 2023

Related U.S. Application Data
(63) Continuation of application No. PCT/CN2023/086893, filed on Apr. 7, 2023.

(51) Int. Cl. G02B 27/01

(52) U.S. Cl. CPC G02B 27/0172; G02B 2027/0118

(57) ABSTRACT

An optical waveguide lens and a near-eye display device are provided. The near-eye display device includes a housing, a projection device and an optical waveguide lens mounted in the housing. The optical waveguide lens images an image produced by the projection device in front of human eyes, and includes stacked optical waveguide sheets. A first air gap is provided between adjacent optical waveguide sheets, and a filling member is provided in the first air gap to fill at least part of the first air gap, reducing the risk of water vapor, dust, and other fine impurities in the external environment entering the first air gap, improving the imaging effect and stability of the optical waveguide lens, and prolonging the service life of the optical waveguide lens, which further improves the operational stability and service life of the near-eye display device and the user experience.

### CROSS-REFERENCE TO RELATED APPLICATION

The present application is a continuation of PCT Patent Application No. PCT/CN2023/086893, filed Apr. 7, 2023, which is incorporated by reference herein in its entirety.

### TECHNICAL FIELD

The present disclosure relates to the field of near-eye display devices, and in particular relates to an optical waveguide lens and a near-eye display device.

### BACKGROUND

A near-eye display device is provided with a projection device and an optical waveguide lens, and the optical waveguide lens images an image generated by the projection device in front of human eyes through reflection and diffraction of the light.

The optical waveguide lens in the existing technology includes a plurality of stacked optical waveguide sheets, with air gaps between adjacent optical waveguide sheets, so as to realize total reflection of light by a lens body of the optical waveguide lens, thereby enhancing the imaging effect. In the process of using, storing, carrying, and transporting the near-eye display device, water vapor, dust, and other fine impurities in an external environment are prone to enter into the air gaps, resulting in deterioration of the imaging effect of the optical waveguide lens.

Therefore, it is necessary to provide an optical waveguide lens and a near-eye display device with stable imaging effect.

### SUMMARY

The present disclosure aims to provide an optical waveguide lens and a near-eye display device with stable imaging effect.

A first aspect of the present disclosure provides an optical waveguide lens, including: at least two optical waveguide sheets, where the at least two optical waveguide sheets are stacked in a thickness direction of the optical waveguide lens, with adjacent optical waveguide sheets fixedly connected to each other; at least one first air gap each provided between the adjacent optical waveguide sheets in the thickness direction of the optical waveguide lens; and at least one filling member each provided within a respective first air gap to fill at least part of the respective first air gap.

As an improvement, each of the at least one filling member includes a light-transmissible member, and each of the at least one filling member has a refractive index less than or equal to 1.3.

As an improvement, each of the at least one filling member has a refractive index greater than or equal to 1.2.

As an improvement, each of the at least one filling member includes transparent adhesive, and the adjacent optical waveguide sheets are fixedly connected to each other by a respective filling member.

As an improvement, each of the at least two optical waveguide sheets includes a lens body and a grating structure disposed on the lens body, and each of the at least one first air gap has a height greater than a height of the grating structure projecting from the lens body in the thickness direction of the optical waveguide lens.

As an improvement, the optical waveguide lens further includes a cover plate, wherein the cover plate is fixedly connected to the at least two optical waveguide sheets, and the cover plate is disposed on at least one side of the at least two optical waveguide sheets in the thickness direction of the optical waveguide lens.

As an improvement, a second air gap is provided between the cover plate and the at least two optical waveguide sheets in the thickness direction of the optical waveguide lens; and a respective filling member is provided within the second air gap to fill at least part of the second air gap.

As an improvement, each of the at least two optical waveguide sheets includes a lens body and a grating structure provided on the lens body, where the second air gap has a height greater than a height of the grating structure protruding from the lens body in the thickness direction of the optical waveguide lens.

As an improvement, the cover plate includes light transmissible resin or light transmissible glass.

A second aspect of the present disclosure provides a near-eye display device, including: a housing; a projection device mounted in the housing; an optical waveguide lens according to any one of the above embodiments, mounted in the housing, wherein the optical waveguide lens is configured to image an image produced by the projection device in front of human eyes.

The beneficial effect of the present disclosure is that by filling at least a portion of the first air gap and at least a portion of the second air gap with the filling members, the risk of water vapor, dust, and other fine impurities in the external environment entering the first air gap and the second air gap is reduced, which improves the imaging effect and the imaging stability of the optical waveguide lens, and is conducive to prolonging service life of the optical waveguide lens, thereby further improving operating stability and service life of the near-eye display device and being conducive to enhancing the user experience.

### BRIEF DESCRIPTION OF THE DRAWINGS

FIG. 1 shows a structural cross-sectional view of an optical waveguide lens provided in an embodiment of the present disclosure.

FIG. 2 shows another structural cross-sectional view of an optical waveguide lens provided in an embodiment of the present disclosure.

### REFERENCE NUMERALS

Optical waveguide sheet 1
Lens body 11
Grating structure 12
First air gap 2
Filling member 3
First filling member 31
Second filling member 32
Cover plate 4
Second air gap 5

### DETAILED DESCRIPTION OF THE EMBODIMENTS

The present disclosure is further described below with reference to the accompanying drawings and embodiments.

Embodiments of the present disclosure provide a near-eye display device, the near-eye display device includes an augmented reality (AR) device and a virtual reality (VR) device, which specifically are headset devices such as glasses, a helmet, a mask, and so on, and the embodiments of the present disclosure do not make a specific limitation on a specific type of the near-eye display device.

The near-eye display device includes a housing, a projection device mounted in the housing, and an optical waveguide lens mounted in the housing. When the user wears the near-eye display device, the optical waveguide lens is located in front of human eyes. During the work of the near-eye display device, the projection device is able to generate a target image, and the optical waveguide lens images the target image in front of the human eyes through reflecting, diffracting, and other operations of the light, thus realizing a near-eye display function of the near-eye display device.

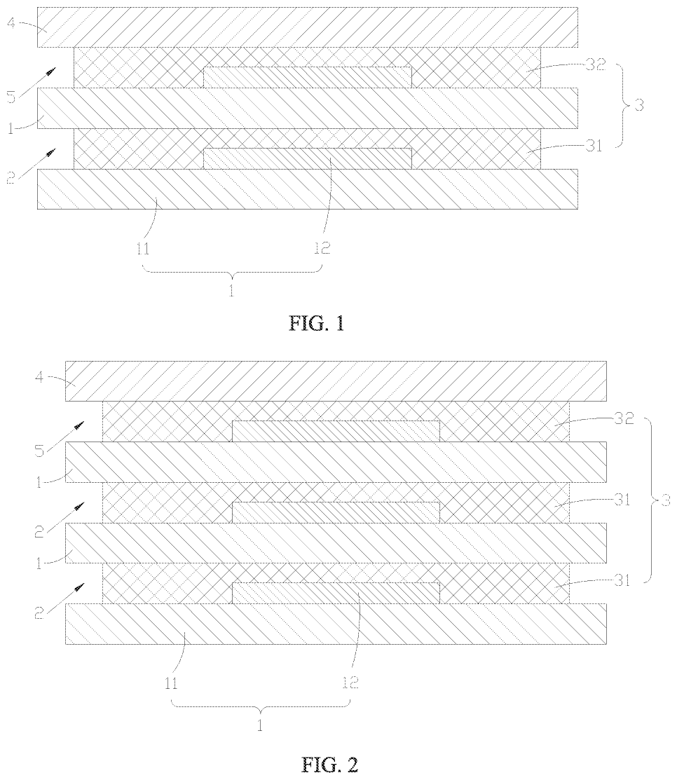

A specific structure of the optical waveguide lens, as shown in FIG. 1, includes at least one optical waveguide sheet 1. When one optical waveguide sheet 1 is provided, an overall thickness of the optical waveguide lens is reduced, thereby reducing the material cost and processing cost of the optical waveguide lens. When a plurality of optical waveguide sheets 1 are provided, the plurality of the optical waveguide sheets 1 are stacked in a thickness direction. The optical waveguide sheets 1 are capable of diffracting light of a specific wavelength, and the plurality of stacked optical waveguide sheets 1 increase a range of wavelengths of light that the optical waveguide lens is capable of diffracting, thereby facilitating the realization of color imaging of the optical waveguide lens, improving the imaging effect of the optical waveguide sheets 1, and thereby further improving the near-eye display effect of the near-eye display device.

As shown in FIG. 1, each optical waveguide sheet 1 includes a lens body 11 and a grating structure 12 disposed on the lens body 11. The grating structure 12 is configured to diffract light, and the lens body 11 is configured for total reflection of light, so that light irradiated on the lens body 11 is totally reflected to the grating structure 12, which reduces the risk of light intensity being weakened by refraction of the light on the lens body 11, thereby improving imaging intensity of the optical waveguide lens, and further enhancing near-eye display intensity of the near-eye display device and improving the user experience.

When the plurality of the optical waveguide sheets 1 are provided, the number of the optical waveguide sheets 1 may be two as shown in FIG. 1, three or even more as shown in FIG. 2, and the embodiments in the present disclosure do not make a specific limitation on the specific number of the optical waveguide sheets 1 to enhance structural flexibility of the optical waveguide lens.

As shown in FIG. 1 and FIG. 2, when the plurality of optical waveguide sheets 1 are stacked in the thickness direction, there exists a predetermined distance between adjacent optical waveguide sheets 1 to form a first air gap 2, and a height of the first air gap 2 is greater than a height of the grating structure 12 protruding from the lens body 11 in the thickness direction of the optical waveguide lens.

In this embodiment, the height of the first air gap 2 is greater than the height of the grating structure 12 protruding from the lens body 11, which reduces the risk of the grating structure 12 on the optical waveguide sheet 1 interfering with the lens body 11 of a neighboring optical waveguide sheet 1, thereby prolonging the service life of the optical waveguide sheets 1 and contributing to the enhancement of the operating stability of the optical waveguide sheets 1, which in turn enhances the operating stability and service life of the optical waveguide lens as well as the near eye display device.

As shown in FIG. 1 and FIG. 2, at least one filling member 3 is each provided within a respective first air gap 2 to fill at least part of the first air gap 2.

In this embodiment, filling the at least part of the first air gap 2 by the filling member 3 reduces the risk of water vapor, dust, and other fine impurities in the external environment entering the first air gap 2, thereby enhancing the imaging effect and the imaging stability of the optical waveguide lens, and contributing to prolonging the service life of the optical waveguide lens, which in turn enhances the operating stability and service life of the near-eye display device and is conducive to enhancing the user experience.

Specifically, each of the at least one filling member 3 includes a light-transmissible member to reduce blocking effect of the filling member 3 on light, thereby facilitating the propagation of light inside the optical waveguide lens, and further enhancing the imaging stability of the optical waveguide lens.

Each of the at least one filling member 3 has a refractive index less than or equal to 1.3, specifically, the refractive index of the filling member 3 is 0.1, 0.3, 0.6, 1.0, 1.2, 1.3 or the like.

In this embodiment, the refractive index of the filling member 3 is less than or equal to 1.3, i.e., the filling member 3 has a lower refractive index, which reduces the refractive effect of the filling member 3 on the light, reduces the light refracted outside the optical waveguide lens by the filling member 3 after total reflection by the lens body 11, and reduces attenuation effect of the light propagating inside the optical waveguide lens, thereby enhancing the imaging intensity of the optical waveguide lens and imaging effect of the near-eye display device.

Each of the at least one filling member 3 has a refractive index greater than or equal to 1.2, i.e., the refractive index of the filling member 3 is between 1.2 and 1.3, specifically, the refractive index of the filling member 3 may be 1.2, 1.24, 1.26, 1.27, 1.3 or the like.

In this embodiment, the refractive index of the filling member 3 is between 1.2 and 1.3, which reduces the refractive effect of the filling member 3 on the light while reducing the cost of the filling member 3, thereby contributing to the reduction of the cost of the optical waveguide lens as well as the near-eye display device.

In addition, each of the at least one filling member 3 includes transparent adhesive, specifically, the transparent adhesive may be a transparent adhesive tape, transparent adhesive water, etc., to increase the structural flexibility of the filling member 3.

The adjacent optical waveguide sheets 1 are fixedly connected to each other by the filling member 3, simplifying the connection between the adjacent optical waveguide sheets 1, reducing the risk of higher connection costs caused by the adjacent optical waveguide sheets 1 being fixedly connected to each other by other structures, thereby facilitating the reduction of the cost of the optical waveguide lens as well as the near-eye display device. Meanwhile, the number of components required for the fixed connection between the adjacent optical waveguide sheets 1 is reduced, which is conducive to reducing a size of the optical waveguide lens, thereby contributing to reducing an overall size of the near-eye display device, and facilitating the transportation and carrying of the near-eye display device.

In any of the above embodiments, as shown in FIG. 1 and FIG. 2, the optical waveguide lens further includes a cover plate 4, which is fixedly connected to the optical waveguide sheets 1. The cover plate 4 is disposed on one or both sides of the optical waveguide sheets 1 in the thickness direction of the optical waveguide lens.

In this embodiment, one side of the optical waveguide sheets 1 is fixedly connected to the cover plate 4 or both sides of the optical waveguide sheets 1 are fixedly connected to two cover plates 4, respectively, which reduces the risk of damage to the optical waveguide sheets 1 by direct exposure to the external environment, thereby prolonging the service life of the optical waveguide sheets 1, and further enhancing the operating stability and service life of the optical waveguide lens as well as the near-eye display device.

Specifically, in the thickness direction of the optical waveguide sheets 1, the cover plate 4 is fixedly connected to one side of the lens body 11 provided with the grating structure 12. Alternatively, in the thickness direction of the optical waveguide sheets 1, the cover plate 4 is fixedly connected to both sides of the optical waveguide sheets 1.

As shown in FIGS. 1 and 2, a second air gap 5 is provided between the cover plate 4 and the optical waveguide sheets 1 in the thickness direction of the optical waveguide sheets 1, and a height of the second air gap 5 is greater than the height of the grating structure 12 protruding from the lens body 11, which reduces the risk of the grating structure 12 on one optical waveguide sheet 1 interfering with the lens body 11 of a neighboring optical waveguide sheet 1, thereby prolonging the service life of the optical waveguide sheets 1 and contributing to enhancing the operating stability of the optical waveguide sheet 1, which in turn enhances the operating stability and service life of the optical waveguide lens as well as the near-eye display device.

As shown in FIG. 1 and FIG. 2, the second air gap 5 is provided with a filling member 3 to fill at least part of the second air gap 5.

In this embodiment, filling the at least part of the second air gap 5 by the filling member 3 reduces the risk of water vapor, dust and other fine impurities in the external environment entering the second air gap 5, thereby enhancing the imaging effect and the imaging stability of the optical waveguide lens and facilitating the prolongation of the service life of the optical waveguide lens, thus further enhancing the operating stability and service life of the near-eye display device and the user experience.

In addition, the filling member 3 in the first air gap 2 is a first filling member 31, and the filling member 3 in the second air gap 5 is a second filling member 32. A material of the first filling member 31 and a material of the second filling member 32 may be the same or different, so as to increase the flexibility of the setting of the first filling member 31 and the second filling member 32. In actual production, processing, and maintenance process, the materials of the first filling member 31 and the second filling member 32 are able to be adaptively adjusted to reduce material cost of the first filling member 31 and the second filling member 32, thereby reducing the processing cost and maintenance cost of the optical waveguide lens.

In any of the above embodiments, the cover plate 4 includes transmissible resin or transmissible glass.

In this embodiment, the cover plate 4 is made of a light-transmissible material, which reduces the blocking of light by the cover plate 4, thereby facilitating a user to see the outside environment and objects through the light-transmissible optical waveguide lens, enabling the user to carry out normal walking, working, and other operations after wearing the near-eye display device, and further improving use scenario of the optical waveguide lens and the near-eye display device and improving the user experience of using the device.

The above description is merely embodiments of the present disclosure, and it should be noted that, for those of ordinary skills in the art, improvements are able to be made without departing from the inventive conception of the present disclosure, all of which fall within the scope of protection of the present disclosure.

What is claimed is:

1. An optical waveguide lens, comprising:
at least two optical waveguide sheets, wherein the at least two optical waveguide sheets are stacked in a thickness direction of the optical waveguide lens, with adjacent optical waveguide sheets fixedly connected to each other;
at least one first air gap each provided between the adjacent optical waveguide sheets in the thickness direction of the optical waveguide lens; and
at least one filling member each provided within a respective first air gap to fill at least part of the respective first air gap.

2. The optical waveguide lens according to claim 1, wherein each of the at least one filling member includes a light-transmissible member, and each of the at least one filling member has a refractive index less than or equal to 1.3.

3. The optical waveguide lens according to claim 2, wherein each of the at least one filling member has the refractive index greater than or equal to 1.2.

4. The optical waveguide lens according to claim 1, wherein each of the at least one filling member includes transparent adhesive, and the adjacent optical waveguide sheets are fixedly connected to each other by a respective filling member.

5. The optical waveguide lens according to claim 1, wherein each of the at least two optical waveguide sheets includes a lens body and a grating structure disposed on the lens body, and each of the at least one first air gap has a height greater than a height of the grating structure projecting from the lens body in the thickness direction of the optical waveguide lens.

6. The optical waveguide lens according to claim 2, wherein each of the at least two optical waveguide sheets includes a lens body and a grating structure disposed on the lens bod, and each of the at least one first air gap has a height greater than a height of the grating structure projecting from the lens body in the thickness direction of the optical waveguide lens.

7. The optical waveguide lens according to claim 1, further comprising a cover plate, wherein the cover plate is fixedly connected to the at least two optical waveguide sheets, and the cover plate is disposed on at least one side of the at least two optical waveguide sheets in the thickness direction of the optical waveguide lens.

8. The optical waveguide lens according to claim 7, wherein a second air gap is provided between the cover plate and the at least two optical waveguide sheets in the thickness direction of the optical waveguide lens; and wherein
a respective filling member is provided within the second air gap to fill at least part of the second air gap.

9. The optical waveguide lens according to claim 8, wherein each of the at least two optical waveguide sheets includes a lens body and a grating structure provided on the lens body, wherein the second air gap has a height greater than a height of the grating structure protruding from the lens body in the thickness direction of the optical waveguide lens.

10. The optical waveguide lens according to claim 7, wherein the cover plate includes light transmissible resin or light transmissible glass.

11. A near-eye display device, comprising:
a housing;
a projection device mounted in the housing;
an optical waveguide lens mounted in the housing, wherein the optical waveguide lens is configured to image an image produced by the projection device in front of human eyes; wherein the optical waveguide lens includes:
at least two optical waveguide sheets, wherein the at least two optical waveguide sheets are stacked in a thickness direction of the optical waveguide lens, with adjacent optical waveguide sheets fixedly connected to each other;
at least one first air gap each provided between the adjacent optical waveguide sheets in the thickness direction of the optical waveguide lens;
at least one filling member each provided within a respective first air gap to fill at least part of the respective first air gap.

12. The near-eye display device according to claim 11, wherein each of the at least one filling member includes a light-transmissible member, and each of the at least one filling member has a refractive index less than or equal to 1.3.

13. The near-eye display device according to claim 12, wherein each of the at least one filling member has the refractive index greater than or equal to 1.2.

14. The near-eye display device according to claim 11, wherein each of the at least one filling member includes transparent adhesive, and the adjacent optical waveguide sheets are fixedly connected to each other by a respective filling member.

15. The near-eye display device according to claim 11, wherein each of the at least two optical waveguide sheets includes a lens body and a grating structure disposed on the lens body, and each of the at least one first air gap has a height greater than a height of the grating structure projecting from the lens body in the thickness direction of the optical waveguide lens.

16. The near-eye display device according to claim 12, wherein each of the at least two optical waveguide sheets includes a lens body and a grating structure disposed on the lens bod, and each of the at least one first air gap has a height greater than a height of the grating structure projecting from the lens body in the thickness direction of the optical waveguide lens.

17. The near-eye display device according to claim 11, wherein the optical waveguide lens further includes a cover plate, wherein the cover plate is fixedly connected to the at least two optical waveguide sheets, and the cover plate is disposed on at least one side of the at least two optical waveguide sheets in the thickness direction of the optical waveguide lens.

18. The near-eye display device according to claim 17, wherein a second air gap is provided between the cover plate and the at least two optical waveguide sheets in the thickness direction of the optical waveguide lens; and wherein
a respective filling member is provided within the second air gap to fill at least part of the second air gap.

19. The near-eye display device according to claim 18, wherein each of the at least two optical waveguide sheets includes a lens body and a grating structure provided on the lens body, wherein the second air gap has a height greater than a height of the grating structure protruding from the lens body in the thickness direction of the optical waveguide lens.

20. The near-eye display device according to claim 17, wherein the cover plate includes light transmissible resin or light transmissible glass.
